(19) United States
(12) Patent Application Publication
(10) Pub. No.: US 2002/0168588 A1
(43) Pub. Date: Nov. 14, 2002

(54) Optical information recording medium

(75) Inventors: Nobuyuki Takamori, Kitakatsuragi-gun (JP); Akira Takahashi, Nara-shi (JP); Hideharu Tajima, Tenri-shi (JP)

Correspondence Address: David G. Conlin, Esq., Edwards & Angell, LLP, Intellectual Property Practice Group, P.O. Box 9169, Boston, MA, 02209, US

(73) Assignee: SHARP KABUSHIKI KAISHA, Osaka (JP)

(21) Appl. No.: 10/139,869

(22) Filed: May 7, 2002

(30) Foreign Application Priority Data
May 14, 2001 (JP) 2001-143861

(51) Int. Cl. G11B 7/26; G11B 7/24

(52) U.S. Cl. 430/270.15; 430/945; 369/283; 430/19; 428/64.8

(57) ABSTRACT

In the optical information recording medium of the present invention, a first recording layer having a translucent film and a second recording layer having a reflection film are layered. At least one layer of the first recording layer is provided, and the translucent film reversibly varies its reflectance and its transmittance according to a temperature variation caused by difference in a converging state of reproducing light. This ensures to obtain a sufficient amount of the reproducing light reflected from the first and second recording layers.

### FIELD OF THE INVENTION

The present invention relates to an optical information recording medium, such as an optical disk, which optically records and reproduces information by using a laser beam, for example.

### BACKGROUND OF THE INVENTION

An optical disk such as a DVD (Digital Versatile Disk) is made by pasting together two transparent plastic substrates whose thickness is 0.6 mm, for example. A recording layer composed of irregular pits is respectively formed between the transparent plastic substrates (hereinafter referred to as substrates).

In this kind of optical disk, among plural types of read only DVDs a type called a two-layer disk in which the respective two substrates have a recording layer is known. In the two-layer disk, as disclosed in Japanese Unexamined Patent Publication No. 2000-285517 (Tokukai 2000-285517; published on Oct. 13, 2000), for example, the surfaces of the two substrates which face each other are respectively provided with a recording layer, and these surfaces are pasted together via a transparent resin layer.

In the two-layer disk, when reproducing, a reproducing light enters through one disk surface to access the two different recording layers. Therefore, the two-layer disk has an advantage of accessing the both recording layers in a short period.

Furthermore, a first recording layer, which is a recording layer on the side from which the reproducing light is directed, has a translucent film, which is designed to reflect a part of the incident reproducing light and transmit the rest of the light.

Therefore, the reproducing light can reach a second recording layer, which is located far away from the side from which the reproducing light is directed. The light reflected from the second recording layer is taken out after transmitting again the first recording layer, thereby ensuring to reproduce the information from the second recording layer.

In the two-layer disk, the first and second recording layers are separated with a spacer, which is the transparent resin layer, so that reproducing signals do not interfere with each other. Therefore, an objective lens is focused on a position corresponding to each recording layer so that information of each recording layer can be reproduced in high quality.

In such a reproducing method, reproducing signal properties largely vary depending on how a translucent film of the first recording layer is designed.

Conventionally, as a material of the translucent film, Au or Ag alloy is generally used because they satisfy optical properties such as reflectance and transmittance as desired, and they can be easily formed into a thin film by using a method such as sputtering.

Furthermore, the alloy has advantages of stable coating on subtle irregular pits formed on the recording layer and excellent weather resistance as an optical information recording medium.

Furthermore, the above-mentioned Tokukai No. 2000-285517 suggests an optical information recording medium having an translucent film composed of an AgPdCu alloy thin film including Pd and Cu, for purposes of reducing cost and improving weather resistance of the translucent film.

In the conventional art, however, in reproducing cases of the respective first and the second recording layers, for example, an arrangement is not fully discussed for obtaining a more sufficient amount of reproducing light and thereby obtaining high signal strength to realize stable reproduction.

This is the same for an arrangement suitable for an optical information recording medium having a plurality of first recording layers. In this respect, for example, the translucent film composed of Au, or the translucent film composed of Ag alloy described in the publication has optical limitations in their reflectance and their transmittance.

For this reason, when used in a disk including a large number of recording layers, or a record reproducible recording film (a mageneto-optical recording film, a phase change recording film, and the like), the above-described translucent films cause a problem of lacking sufficient reproducing signal strength.

### SUMMARY OF THE INVENTION

The object of the present invention is to provide an optical information recording medium that can obtain sufficient reproducing signal strength and thereby realizes stable reproduction in an arrangement having a plurality of recording layers.

In order to achieve the above object, an optical information recording medium of the present invention, in which at least one first recording layer having a translucent film and a second recording layer having a reflection film are layered, may be so arranged that reflectance and transmittance reversibly vary in the translucent film according to a temperature variation caused by difference in a converging state of irradiation light.

According to the above optical information recording medium, the reflectance and the transmittance reversibly vary in the translucent film of the first recording layer according to a temperature variation caused by difference in the converging state of irradiation light, namely a rise in temperature when the irradiation light (for example, a laser beam) is in the converging state, and a fall in temperature in a non-converging state.

Therefore, in a relatively low temperature state when the irradiation light is in the non-converging state, the translucent film turns to, for example, a non-coloring state of light transmittance having low reflectance and high transmittance. On the other hand, in a high temperature state when the irradiation light is in the converging state, the translucent film turns to a coloring state, for example, having high reflectance and low transmittance.

For example, when reproducing the first recording layer, the reproducing light is converged on (focused on) the first recording layer and irradiated as a reproducing light spot. In this case, the spot irradiated part in the translucent film, especially a center part having strong optical energy, locally raises its temperature.

Then the temperature rising part, for example, raises its reflectance (lowers its transmittance) by coloring. Therefore, the reproducing light is surely reflected on the translucent film so that a sufficient amount of reflection light can be obtained as a reproducing signal.

On the other hand, for example, when reproducing the second recording layer, the reproducing light is irradiated, with being converged on the second recording layer. In this case, without being converged with the reproducing light, the first recording layer turns to a relatively low temperature state.

As a result, the translucent film turns to, for example, the non-coloring state, and thus raises its light transmittance (lowers its reflectance). Because of this, the reproducing light can transmit the first recording layer so as to reach the second recording layer.

The reproducing light reached the second recording layer is reflected on a reflection film of the second recording layer to become a reproducing signal, and is taken out after transmitting again the first recording layer. Therefore, also in this case, a sufficient amount of reflection light can be obtained as a reproducing signal.

The above operations can be carried out in the same way even when a plurality of the first recording layers are provided. As a result, it is possible to read recorded information from all the recording layers with keeping signal quality above a constant level.

For a fuller understanding of the nature and advantages of the invention, reference should be made to the ensuing detailed description taken in conjunction with the accompanying drawings.

### BRIEF DESCRIPTION OF THE DRAWINGS

FIG. 1 is a side view showing an optical information recording medium in accordance with an embodiment of the present invention.

FIG. 2 is a side view showing a first recording layer of the optical information recording medium.

FIG. 3 is a side view showing a second recording layer of the optical information recording medium.

FIG. 4(a) is an explanatory diagram showing a reproducing mechanism of the first recording layer of the optical information recording medium in accordance with the embodiment of the present invention, and

FIG. 4(b) is an explanatory diagram showing a reproducing mechanism of the second recording layer.

FIG. 5 is an explanatory diagram explaining an example of a manufacturing method of the present optical information recording medium shown in FIG. 1.

### DESCRIPTION OF THE EMBODIMENTS

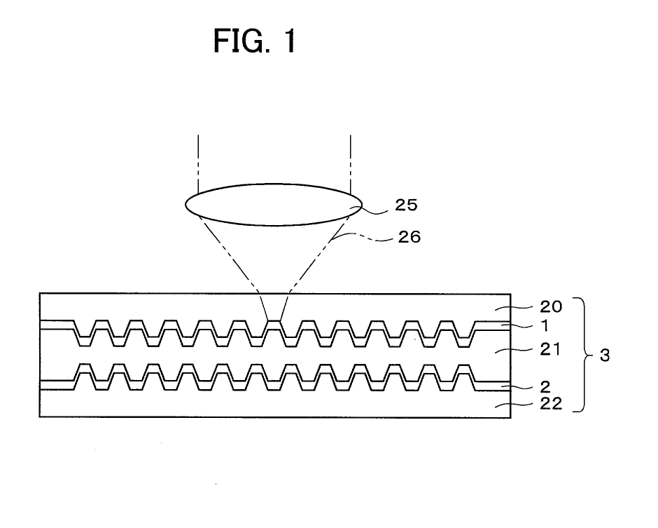

An embodiment of the present invention is explained as follows, referring to FIGS. 1 through 5.

An optical information recording medium in the present embodiment has a multi-layer structure, as shown in FIG. 1. The optical information recording medium has a transparent substrate 20 as one outermost layer, and a transparent or opaque protection layer 22 as the other outermost layer.

The transparent substrate 20 and the protection layer 22 are composed of, for example, plastic such as polycarbonate and amorphouspolyolefine, or acrylic resin of an ultraviolet curing type.

A surface on an inner layer side of the transparent substrate 20 is provided with a first recording layer 1 to which information is recorded, whereas a surface on an inner layer side of the protection layer 22 is similarly provided with a second recording layer 2 for recording information.

Between the first recording layer 1 and the second recording layer 2 is provided with a transparent resin layer 21 having a predetermined thickness. In other words, the transparent substrate 20 and the protection layer 22 are pasted with the transparent resin layer 21 via the first and the second recording layers 1 and 2, thereby forming an optical information recording medium 3.

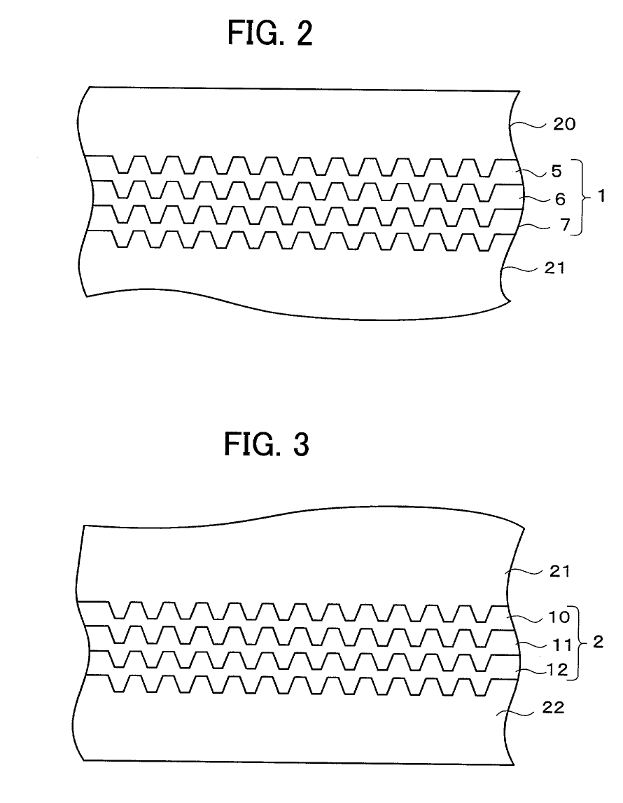

The first recording layer 1 is composed of a dielectric film 5, a recording film 6, and a translucent film 7, as shown FIG. 2.

The dielectric film 5 is composed of a material such as SiN. The recording film 6 uses materials composed of TbFeCo and the like, which is applicable to magneto-optical recording, phase change recording materials such as GeTeSb or AgInSb which is applicable to optical recording, or organic pigment materials such as cyanine or phthalocyanine.

Moreover, the translucent film 7 (details are described later) is formed by using a sputtering method, generally a magnetron sputtering method, because of easy manufacturing or other reasons. The first recording layer 1 forms irregular patterns and guiding grooves according to information, for example, as information pits.

The second recording layer 2 is composed of a dielectric film 10, a recording film 11, and a reflection film 12, as shown in FIG. 3.

The dielectric film 10 and the recording film 11 are formed with the same materials as the dielectric film 5 and the recording film 6, respectively, of the first recording layer 1.

The reflection film 12 is composed of Al, Au, or Ag having high reflectance or their alloy, and formed by using the sputtering method. The second recording layer 2, like the first recording layer 1, forms irregular patterns and guiding grooves according to information, for example, as information pits.

In reproducing the optical information recording medium 3, the irregular information pits of the first recording layer 1 or the second recording layer 2 guide a reproducing light 26 (a laser beam) to specify its reflection light as a reproducing signal.

Therefore, for accurately reproducing information, reproducing signal strength, which is obtained from the first recording layer 1 and the second recording layer 2, is preferably high (an amount of reflection light is large).

In a further detailed explanation of the above respect, the information pits formed on the first recording layer 1 is reproduced in such a way that an objective lens 25, which is adjusted its focus point, focuses the reproducing light 26, which is directed from the side of the transparent substrate 20, on the first recording layer 1.

On the other hand, the second recording layer 2 is reproduced in such a way that the objective lens 25 focuses the reproducing light 26 on the second recording layer 2. For this reason, the translucent film 7 is required to have two functions below.

\mathring{1} To reflect the reproducing light to the first recording layer 1 (the recording film 6) as much as possible.

\mathring{2} To let the reproducing light to the second recording layer 2 reach the second recording layer 2 (the recording film 11) as much as possible without interrupted.

For obtaining above functions, the translucent film 7 in the present optical information recording medium is arranged as follows.

The translucent film 7 is arranged to include a material in which the reflectance and the transmittance vary according to the temperature. More specifically, when the temperature rises, the translucent film 7 raises its reflectance and lowers its transmittance (a high reflectance state), and thus turns to a coloring state that reflects light.

On the other hand, when the temperature falls, the translucent film lowers its reflectance and raises its transmittance (a high transmittance state), and thus turns to a non-coloring state of light-transmittance.

A temperature range of the high reflectance state can be specified as 60° C. to 180° C., for example, whereas a temperature range of the high transmittance state can be specified as 20° C. to 60° C., for example.

A concrete material used for the translucent film 7 can be a photochromism material composed of a compound mainly composed of spiropyrane, spironaphthooxazine, azobenzene, flugide, or diallylethene.

The photochromism material is a material in which absorption of a photon causes a change in its compound structure, and thereby varies its refractive index.

Moreover, the translucent film 7 can use a thermochromism material in which alkali is added to lactone or fluorene, or a thermochromism material in which organic acid is added to leuco pigment.

The thermochromism material is a material in which absorption of heat chemically causes a change in its structure, and thereby varies its refractive index.

Moreover, the translucent film 7 can use an inorganic compound mainly composed of Sb, Ge, or Si, or a metal oxide complex mainly composed of Bi₂O₃-Cr₂O₃.

Moreover, the translucent film 7 can use heavy metal iodide mainly composed of Ag₂HgI₄ or Cu₂HgI₄.

The materials of the translucent film 7 such as the photochromism material or the thermochromism material are materials in which the refractive index vary and thus the reflectance and the transmittance vary according to a converging state of the reproducing light, namely a state of a temperature variation generated by converging optical energy.

In concrete, in the materials of the translucent film, the refractive index varies and thus the reflectance (the coloring state) rises because of condensation of the reproducing light, namely a rise in temperature caused by the optical energy.

On the other hand, when the reproducing light is not converged and the temperature is relatively low, the light transmittance rises (the reflectance lowers). For this reason, the material is suitable for the material of the translucent film.

By the way, in the translucent film 7, generally, the reflectance rises and the transmittance conversely lowers as the film thickens. For this reason, it is required to set the film thickness appropriate for fully reflecting the reproducing light. In the present embodiment, the translucent film is desirably 2 nm to 100 nm.

The translucent film has a thickness of 2 nm to 100 nm, because a thin film whose thickness is less than 2 nm is difficult to be evenly formed, and a film whose thickness is more than 100 nm cannot fully absorb light, and thus cannot obtain a sufficient amount of the reflection light.

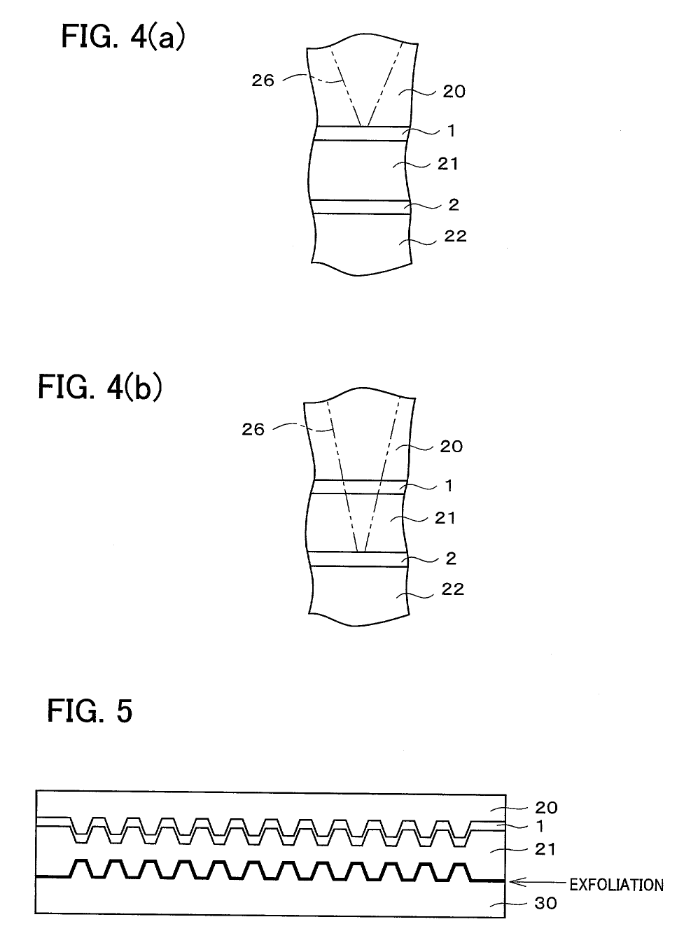

Next, referring to FIGS. 4(a) and (b), a reproducing mechanism of the optical information recording medium having the translucent film 7 is explained.

FIG. 4(a) shows a case when the first recording layer 1 is reproduced. In this case, the reproducing light 26 is focused on the first recording layer 1 to carry out spot irradiation.

Because of this, in the translucent film 7, a local temperature rise occurs in a spot irradiated portion, especially a central portion having strong optical energy. This causes the coloring in a portion which falls within a spot diameter of the reproducing light 26, thereby raising its reflectance.

Therefore, this satisfies the function of \mathring{1}. In other words, the translucent film 7 can reflect the reproducing light 26 to generate a reflection light which a reproducing signal.

FIG. 4(b) shows a case when the reproduction is carried out with respect to the second recording layer 2. In this case, the reproducing light 26 is focused on the second recording layer 2 to carry out the spot irradiation. For this reason, the reproducing light 26 is defocused on the first recording layer 1 (a non-converging state), and thus the first recording layer 1 is not converged with optical energy. This causes the first recording layer 1 to be a state where the optical energy does not raise the temperature, namely a relatively low temperature state.

This ensures the translucent film in the first recording layer 1 to be the non-coloring state, so as to raise its light transmittance. This satisfies the function of \mathring{2}. In other words, the reproducing light 26 can transmit the first recording layer 1 and reach the second recording layer 2.

After that, the reproducing light which has reached the second recording layer 2 is reflected from the reflection film 12 in the second recording layer 2. The reflection light transmits again the first recording layer 1 having the translucent film 7 to be used as a reproducing signal.

As described above, when the reproducing light 26 is converged on the first recording layer 1, which is a layer closer to the side from which the reproducing light 26 is directed, the temperature rise occurs in the translucent film 7 of the first recording layer 1 so that the reflectance increases (the transmittance lowers). Therefore, the reproducing light 26 reflected from the translucent film 7 is allowed to have a sufficient light amount, and thus the reproducing signal using the reproducing light 26 becomes fine.

Moreover, when the reproducing light 26 is converged on the second recording layer 2, which is a layer further to the side from which the reproducing light 26 is directed, the transmittance increases (the reflectance lowers) in the translucent film 7 of the first recording layer 1 because no temperature rise occurs in the translucent film 7. Therefore, the reproducing light 26 can transmit the first recording layer 1 and reach the second recording layer 2. The reproducing light 26 is then reflected from the reflection film 12 and transmits again the translucent film 7 to be taken out in a state having a sufficient light amount. This makes the reproducing signal using the reproducing light 26 fine.

As described above, in the present optical information recording medium, in the both reproducing cases of the first recording layer 1 and the second recording layer 2, an amount of reflection light of the reproducing light 26 can be restricted to reduce. This makes it possible to obtain sufficient reproducing signal strength.

Namely, in the optical information recording medium having a large number of recording layers, it is possible to read the recorded information from all the recording layers with keeping signal quality above a constant level.

The optical information recording medium of the present embodiment can be manufactured in a method shown in FIG. 5, for example. In manufacturing, an original plate 30 is prepared, which has a surface (an information recording surface) engraved with information pits and grooves of the second recording layer 2.

First, a layered product layered with the first recording layer 1 is manufactured on the transparent substrate 20. Next, the layered product and the original plate 30 are pasted via an acrylic resin of an ultraviolet curing type, for example, in such a manner that the surface of the layered product on a side of the first recording layer 1 and the information recording surface of the original plate 30 are faced.

The acrylic resin of the ultraviolet curing type is cured by ultraviolet irradiation to become the transparent resin layer 21. The thickness of the transparent resin layer 21 is preferably 5 μm to 100 μm so as to obtain a distance that reproducing signals from the first recording layer 1 and the second recording layer 2 do not interfere with each other.

Next, the original plate 30 is exfoliated from the transparent resin layer 21. According to this, the information recording surface (information pits and grooves) of the original plate 30 can be transcribed on the transparent resin layer 21.

After that, the information recording surface of the transparent resin layer 21 is sequentially layered with the dielectric film 10, the recording film 11, and the reflection film 12, to form the second recording layer 2.

Furthermore, the protection layer 22 is provided on the second recording layer 2 to become the information recording medium. The protection layer 22 is formed in such a manner that ultraviolet curing resin is applied by spin coating and then cured by ultraviolet irradiation. The thickness of such a protection layer is preferably about 1 μm to 30 μm.

A disk having two recording layers in the embodiment of the present invention may be disk-like optical disks such as an MD (Mini Disk), a CD (Compact Disk), a CD-R (Compact Disk-Recordable), a CD-RW (Compact Disk-Rewritable), a CD-ROM (Compact Disk-Read Only Memory), a DVD, a DVD-R, a DVD-RW, a DVD-ROM, a DVD-RAM (Digital Versatile Disk-Random Access Memory), a DVD+RW, and an MO (Magneto-Optical), for example, but not limited to these.

Furthermore, the embodiment of the present invention shows the disk having two recording layers, but this may be applied to a variety of optical information recording media having a metal thin film as a recording layer, such as an optical disk, a magneto-optical disk, an optical disk of a phase change type, or other card-like or sheet-like recording media, which have one or not less than three recording layers.

The optical information recording medium having only one recording layer may be arranged to include the recording film G on the reflection film composed of the translucent film 7 (on the side from which light is directed), for example; more specifically, to include the first recording layer 1, for example.

In the optical information recording medium, a layer corresponding to the reflection film is a material in which the refractive index varies according to the temperature. For this reason, in the reflection film, the reflectance and the transmittance reversibly vary only in the central portion in which the temperature rise occurs due to the converging of the irradiation light. This makes it possible to reproduce only the central portion, which falls within the spot diameter of the irradiation light.

This is a super resolution reproducing method of a reflection type completely different from a conventional super resolution reproducing method in which the transmittance varies on the side from which the light is directed.

Furthermore, in the foregoing description, the reproducing mechanism of the optical information recording medium is explained. However, it is obvious that the present optical information recording medium can be applied to a case when recording light is used for recording information on the first recording layer 1 or the second recording layer 2, namely a recording mechanism using the recording light.

Therefore, this can be applied to optical information recording media such as the CD-R, the CDRW, the DVD-R, or the DVD-RW, to which information can be written.

Furthermore, the structure of the present optical information recording medium is not limited to the above-described structures. For example, the light information recording medium may be structured in such a manner that two or more recording layers are formed on the respective two transparent substrates, which are then combined together so that the respective surfaces having the recording layers face each other, and the medium is subjected to light irradiation from sides of the respective transparent substrates. As described above, the present optical information recording medium can have a variety of structures.

Furthermore, it is obvious that the present invention is not limited to the above-described embodiments and can adapt other various arrangements without deviating the gist of the present invention.

Moreover, the optical information recording medium of the present invention may be so arranged that the translucent film includes a material in which the light refractive index varies depending on the temperature.

According to the arrangement, since the light refractive index varies depending on the temperature in the translucent film of the first recording layer, the reflectance and the transmittance appropriately vary according to a temperature variation caused by difference in a converging state of irradiation light.

Moreover, the optical information recording medium of the present invention may be so arranged that the material of the translucent film is a photochromism material including at least one compound selected from the group consisting of compounds mainly composed of spiropyrane, spironaphthooxazine, azobenzene, fulgide, or diallylethene.

According to the arrangement, the converging state of the reproducing light, namely the state of the temperature variation caused by the optical energy, can vary the light refractive index and thus appropriately vary the reflectance and the transmittance.

Moreover, the optical information recording medium of the present invention may be so arranged that the material of the translucent film is a thermochromism material in which alkali is added to a compound mainly composed of lactone or fluorene.

According to the arrangement, the converging state of the reproducing light, namely the state of the temperature variation caused by the optical energy, can vary the light refractive index and thus appropriately vary the reflectance and the transmittance.

Moreover, the optical information recording medium of the present invention may be so arranged that the material of the translucent film is a thermochromism material in which organic acid is added to leuco pigment.

According to the arrangement, the converging state of the reproducing light, namely the state of the temperature variation caused by the optical energy, can vary the light refractive index and thus appropriately vary the reflectance and the transmittance.

Moreover, the optical information recording medium of the present invention may be so arranged that the material of the translucent film is at least one inorganic compound selected from the group consisting of inorganic compounds mainly composed of Sb, Ge, or Si.

According to the arrangement, the converging state of the reproducing light, namely the state of the temperature variation caused by the optical energy, can vary the light refractive index and thus appropriately vary the reflectance and the transmittance.

Moreover, the optical information recording medium of the present invention may be so arranged that the material of the translucent film is a metal oxide complex mainly composed of Bi₂O₃-Cr₂O₃.

According to the arrangement, the converging state of the reproducing light, namely the state of the temperature variation caused by the optical energy, can vary the light refractive index and thus appropriately vary the reflectance and the transmittance.

Moreover, the optical information recording medium of the present invention may be so arranged that the material of the translucent film is heavy metal iodide mainly composed of Ag₂HgI₄, or Cu₂HgI₄.

According to the arrangement, the converging state of the reproducing light, namely the state of the temperature variation caused by the optical energy, can vary the light refractive index and thus appropriately vary the reflectance and the transmittance.

Moreover, the optical information recording medium of the present invention may be so arranged that a thickness of the translucent film is 2 nm to 100 nm.

The translucent film is generally known to raise its reflectance and conversely lower its transmittance as the film thickens. Thus, as a preferred thickness of the translucent film of the first recording layer, the above-mentioned thickness was obtained.

With the above film thickness, the reproducing light can be reflected when converged on the first recording layer, whereas the reproducing light can be transmitted when not converged on the first recording layer. For this reason, a sufficient reproducing signal (reflection light) can be obtained from the first reflection layer. Further, the reproducing light which transmits the first recording layer reaches the second recording layer and is then reflected from the reflection film of the second recording layer to become a sufficient reproducing signal (reflection light).

Therefore, in the optical information recording medium having a large number of recording layers, it is possible to read recorded information from all the recording layers with keeping signal quality above a constant level.

Moreover, the optical information recording medium of the present invention may be so arranged that the recording layer is formed with a single film or a plurality of films, and the recording layer is not only a read only type but also a write once type that can record information only once, or a rewritable recording and reproduction type that can record information any times.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

What is claimed is:

1. An optical information recording medium in which at least one first recording layer having a translucent film and a second recording layer having a reflection film are layered, wherein:
reflectance and transmittance reversibly vary in the translucent film according to a temperature variation caused by difference in a converging state of irradiation light.

2. The optical information recording medium as set forth in claim 1, wherein:
the translucent film includes a material in which light refractive index varies depending on the temperature variation.

3. The optical information recording medium as set forth in claim 2, wherein:
the material of the translucent film is a photochromism material including at least one compound selected from the group consisting of compounds mainly composed of spiropyrane, spironaphthooxazine, azobenzene, fulgide, or diallylethene.

4. The optical information recording medium as set forth in claim 2, wherein:
the material of the translucent film is a thermochromism material in which alkali is added to a compound mainly composed of lactone or fluorene.

5. The optical information recording medium as set forth in claim 2, wherein:
the material of the translucent film is a thermochromism material in which organic acid is added to leuco pigment.

6. The optical information recording medium as set forth in claim 2, wherein:
the material of the translucent film is at least one inorganic compound selected from the group consisting of inorganic compounds mainly composed of Sb, Ge, or Si.

7. The optical information recording medium as set forth in claim 2, wherein:
the material of the translucent film is a metal oxide complex mainly composed of Bi₂O₃-Cr₂O₃.

8. The optical information recording medium as set forth in claim 2, wherein:
the material of the translucent film is heavy metal iodide mainly composed of Ag₂HgI₄, or Cu₂HgI₄.

9. The optical information recording medium as set forth in claim 1, wherein:
the translucent film has a thickness of 2 nm to 100 nm.

10. The optical information recording medium as set forth in claim 1, wherein:
the recording layer has a single film or a plurality of films, and has a function of either read only, write once, or recording and reproduction.

11. The optical information recording medium as set forth in claim 1, wherein:
the translucent film raises its reflectance and lowers its transmittance in a high temperature state, whereas the translucent film lowers its reflectance and raises its transmittance in a low temperature state.

12. The optical information recording medium as set forth in claim 1, further comprising:
a transparent resin layer, which is provided between the first recording layer and the second recording layer, the transparent resin layer having a film thickness of 5 nm to 100 nm.

13. An optical information recording medium, comprising:
a recording layer, including (a) a translucent film in which reflectance and transmittance reversibly varies according to a temperature variation caused by difference in a converging state of irradiation light, and (b) a recording film provided on a side of the translucent film from which the irradiation light is directed.
